(19) United States
(12) Patent Application Publication
(10) Pub. No.: US 2024/0282260 A1
(43) Pub. Date: Aug. 22, 2024

(54) DISPLAY, ELECTRONIC DEVICE, AND METHOD FOR MANUFACTURING DISPLAY

(71) Applicant: HONOR DEVICE CO., LTD., Shenzhen, Guangdong (CN)

(72) Inventor: Fuyang ZHANG, Shenzhen (CN)

(21) Appl. No.: 18/024,560

(22) PCT Filed: Aug. 26, 2022
(86) PCT No.: PCT/CN2022/115062

§ 371 Date: Mar. 3, 2023

(30) Foreign Application Priority Data
Nov. 30, 2021 (CN) 202111447500.6

(51) Int. Cl. G09G 3/3233; G09G 3/32; G09G 3/36

(52) U.S. Cl. CPC G09G 3/3233; G09G 3/32; G09G 3/3648; G09G 2320/0233; G09G 2320/0242

(57) ABSTRACT

Embodiments of this application disclose a display, including a first display area and a second display area that have an included angle, a first drive circuit provides a current for the first display area, a second drive circuit provides a current for the second display area, both the first drive circuit and the second drive circuit are provided with a drive transistor, and at least one structure parameter of the drive transistor of the first drive circuit and the drive transistor of the second drive circuit is different to provide different currents. Different drive circuit currents are provided by changing a structure parameter of the drive transistor in the drive circuit, to compensate for a display brightness change or color cast that exists in different display areas due to an included angle, so that a display effect of the entire display area is consistent.

This application claims priority to Chinese Patent Application No. 202111447500.6, filed with the China National Intellectual Property Administration on Nov. 30, 2021 and entitled “DISPLAY, ELECTRONIC DEVICE, AND METHOD FOR MANUFACTURING DISPLAY”, which is incorporated herein by reference in its entirety.

### TECHNICAL FIELD

This application relates to the field of electronic device technologies, and in particular, to a display, an electronic device, and a method for manufacturing a display.

### BACKGROUND

Currently, a curved screen has emerged on a market, which brings an important breakthrough to an appearance of a product. A most intuitive feeling is that a non-display area at an edge is reduced, a screen ratio of a display area is increased, and appearance of a curved surface also puts forward a higher display requirement for a display. However, in a use process of an existing curved screen, display intensity attenuation and screen color cast may occur on both sides of the screen.

### SUMMARY

Embodiments of this application provide a display, and currents of drive circuits may be designed to be different to compensate for a display difference caused by different display conditions.

According to a first aspect, an embodiment of this application provides a display. The display includes a first display area and a second display area that have an included angle, and further includes a first drive circuit and a second drive circuit. The first drive circuit provides a current for the first display area, and the second drive circuit provides a current for the second display area. Both the first drive circuit and the second drive circuit are provided with a drive transistor, and at least one structure parameter of the drive transistor of the first drive circuit and the drive transistor of the second drive circuit is different. In this way, the first drive circuit and the second drive circuit may provide different currents. By changing structure parameters of drive transistors of drive circuits of different display areas that have an included angle, currents provided by the drive circuits may be changed, so that the display areas with different included angles have different currents, to compensate for a display brightness change or color cast caused by an included angle between the display areas, thereby ensuring that a display effect of an entire display area is consistent. It should be noted that this adjustment manner can implement continuous adjustment of brightness and color cast of the display, and has a large design and adjustment space. In addition, the display can be optimized and adjusted without increasing manufacturing costs or changing a main structure of the drive circuit.

Based on the first aspect, an embodiment of this application further provides a first

implementation of the first aspect.

Structure parameters of the drive transistor include u, Cₒₓ, W, and L, where L is a channel length, W is a channel width, u is a carrier mobility, Cₒₓ is a gate capacitance per unit area, and a current provided by the drive circuit is positively correlated with uCₒₓW/L. According to a principle of the drive circuit, a current of the drive circuit is positively correlated with uCₒₓW/L. Therefore, different currents can be obtained by adjusting at least one parameter of u, Cₒₓ, W, and L, and the design is simple.

Based on the first implementation of the first aspect, an embodiment of this application further provides a second implementation of the first aspect.

Linear distances between two ends of channels of the drive transistor of the first drive circuit and the drive transistor of the second drive circuit are the same, but bending degrees or bending times of the channels are different to have different channel lengths. For example, a channel with more bending times is longer than a channel with fewer bending times. It can be learned that, by designing a bending degree and bending times of the drive transistor, a semiconductor channel length of the drive transistor can be changed, which makes the design of the semiconductor more flexible.

Based on the first implementation of the first aspect, an embodiment of this application further provides a third implementation of the first aspect.

The drive transistor of the first drive circuit and the drive transistor of the second drive circuit have different grain sizes of semiconductor films to have different carrier mobility. A change of the grain size can be implemented by changing process parameters for processing, and therefore can be easily implemented.

Based on the first implementation of the first aspect, an embodiment of this application further provides a fourth implementation of the first aspect.

The drive transistor includes a channel and a first gate insulation layer covering the channel, and a gate capacitance per unit area Cₒₓ=λε₀ε_{GI1}/d_{GI1},GII/dGn, ε₀ is a vacuum permittivity, ε_{GI1} is a permittivity of the gate oxide layer, and d_{GI1} is a thickness of the first gate insulation layer 4. A thickness of the first gate insulation layer of the drive transistor of the first drive circuit and a thickness of the first gate insulation layer of the drive transistor of the second drive circuit may be designed to be different. In this way, the drive transistor of the first drive circuit and the drive transistor of the second drive circuit may have different gate capacitance per unit area, and different currents may be provided, and such a design is also easy to process.

Based on the first aspect and the first to the fourth implementations of the first aspect, an embodiment of this application further provides a fifth implementation of the first aspect.

Due to different angles between the first display area and the second display area, brightness attenuation or color cast may occur based on a difference in viewing angle. In a specific design, a current provided by a corresponding drive circuit of one of the first display area and the second display area that has lower display brightness may be greater than a current provided by the other drive circuit. In this way, the display area with lower brightness may obtain a higher current, to compensate for a difference in display brightness and eliminate color cast. The display area with lower display brightness herein refers to the display area with lower display brightness in a case in which the first display area and the second display area have a same drive circuit design.

Based on the first aspect and the first to the fifth implementations of the first aspect, an embodiment of this application further provides a sixth implementation of the first aspect.

The display is a curved screen, and the curved screen includes a curved display area and a main display area. The main display area is the first display area, and an area with any bending angle in the curved display area is the second display area. An area with any bending angle in the curved display area has an included angle with the main display area, and therefore, structure parameters of the drive transistors in each area with a bending angle and the main display area are designed to be different to obtain different currents.

Based on the sixth implementation of the first aspect, an embodiment of this application further provides a seventh implementation of the first aspect.

In the curved display area, included angles between areas with different bending angles and the main display area are different. A larger bending angle indicates a larger included angle between the area with a bending angle and the main display area, and a larger difference in viewing angle. Therefore, not only at least one structure parameter of the drive transistor of the second drive circuit corresponding to each area with a bending angle is different from that of the drive transistor corresponding to the main display area, but also a larger bending angle of the curved display area indicates a higher current provided by the corresponding second drive circuit after a structure parameter is adjusted, to compensate for a display difference caused by different included angles.

Based on the sixth implementation of the first aspect, an embodiment of this application further provides an eighth implementation of the first aspect.

The main display area is corresponding to a plurality of first drive circuits, and structure parameters of drive transistors in the plurality of first drive circuits are the same. The main display area of the curved screen is set to a flat display area, the structure parameters of the drive transistors are the same, a same current may be provided, and a same component array can be set.

Based on the first aspect and the first to the eighth implementations of the first aspect, an embodiment of this application further provides a ninth implementation of the first aspect.

The display is an organic light-emitting display, a liquid crystal display, or a light-emitting diode display. Such a display uses a drive transistor, and a design of the transistor makes it easy to adjust a current.

According to a second aspect, an embodiment of this application further provides an electronic device, including the display according to any one of the foregoing implementations, and the display has a same technical effect as the foregoing display.

According to a third aspect, an embodiment of this application further provides a method for manufacturing a display, where the display includes a first display area and a second display area that have an included angle. In this method, a first drive circuit that provides a current for the first display area and a second drive circuit that provides a current for the second display area need to be processed. Both the first drive circuit and the second drive circuit are provided with a drive transistor, and the drive transistor controls a current of the first drive circuit or the second drive circuit. When the drive transistor of the first drive circuit and the drive transistor of the second drive circuit are processed, at least one structure parameter of the two drive transistors is different to provide different currents, to compensate for a display difference caused by the included angle between the display areas.

Based on the third aspect, an embodiment of this application further provides a first

implementation of the third aspect.

Structure parameters of the drive transistor include u, Cₒₓ, W, and L, where L is a channel length, W is a channel width, u is a carrier mobility, Cₒₓ is a gate capacitance per unit area, and a current provided by the drive circuit is positively correlated with uCₒₓ W/L.

Based on the third aspect, an embodiment of this application further provides a second implementation of the third aspect.

Semiconductors of the drive transistor of the first drive circuit and the drive circuit of the second drive circuit may be processed by using an excimer laser annealing process, so that amorphous silicon is converted into polycrystalline silicon by using the process. Process parameters of the excimer laser annealing process includes a laser scanning time, laser energy, and a laser scanning quantity. Different process parameters affect parameters of the polycrystalline silicon, for example, a film grain size of the semiconductor. Therefore, when the drive transistor of the first drive circuit and the drive transistor of the second drive circuit are processed, the process parameters of the excimer laser annealing process may be adjusted, so that grain sizes of the semiconductor films of the drive transistor of the first drive circuit and the drive transistor of the second drive circuit are different.

Based on the third aspect, an embodiment of this application further provides a fourth implementation of the third aspect.

The display is a curved screen, and the curved screen includes a curved display area and a main display area. The main display area is the first display area, and an area with any bending angle in the curved display area is the second display area. The first drive circuit and the second drive circuit are both designed in an array, and each area with a bending angle of the curved display area is corresponding to one column of second drive circuits. During processing, each column of the first drive circuits and the second drive circuits may be sequentially scanned, and when the drive transistor of the second drive circuit is scanned, at least one process parameter is adjusted, so that the grain sizes of the drive transistor films of each column of the second drive circuits are different from each other.

### BRIEF DESCRIPTION OF DRAWINGS

FIG. 1 is a schematic diagram of a curved screen;

FIG. 2 is an enlarged view of a part A in FIG. 1;

FIG. 3 shows change of luminous brightness of a display with change of a viewing angle;

FIG. 4 is a schematic diagram of display brightness attenuation and color cast of a curved screen;

FIG. 5 is a schematic diagram of a drive circuit of an OLED display;

FIG. 6 is a sectional view of a drive transistor T1 in FIG. 5;

FIG. 7 is a schematic diagram showing a comparison of channel lengths at different positions in a curved display area of a curved screen in Embodiment 1;

FIG. 8 is a schematic diagram showing a comparison of channel lengths and widths at different positions in a curved display area of a curved screen Embodiment 2;

FIG. 9 is a schematic diagram showing a comparison of channel shape changes at different positions;

FIG. 10 is a schematic diagram showing a comparison of thicknesses of first gate insulation layers at different positions in a curved display area of a curved screen in Embodiment 3;

FIG. 11 is a schematic diagram showing a comparison of grain sizes of semiconductor films at different positions in a curved display area of a curved screen in Embodiment 4; and

FIG. 12 is a schematic diagram showing a comparative relationship between a current change and a display brightness change at different bending positions of a display.

### DESCRIPTION OF EMBODIMENTS

Embodiments of this application provide a display of an electronic device, for example, a display of a mobile phone. The display includes a display layer and a drive circuit that provides a current for the display layer to drive the display layer to display. The display layer includes a plurality of pixel units, and each pixel unit is provided with a corresponding drive circuit. Currently, in a display, all drive circuits that drive the entire display layer to display adopt an array design with a same component structure, that is, drive circuits corresponding to any position in a display area of the display layer use a same component parameter. Correspondingly, currents of the display at any position of the display area are the same. In this embodiment of this application, an organic light-emitting diode (organic light-emitting diode, OLED) display is used as an example for description.

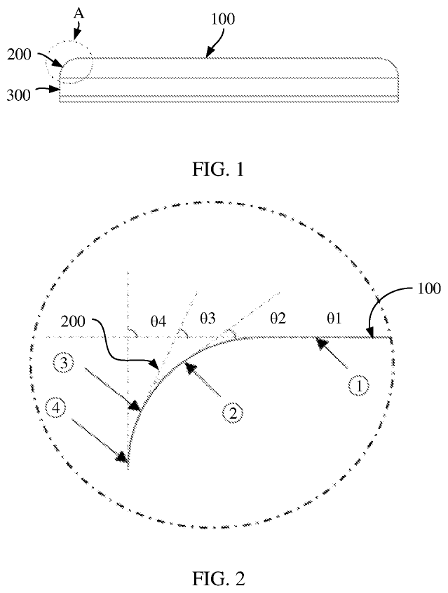

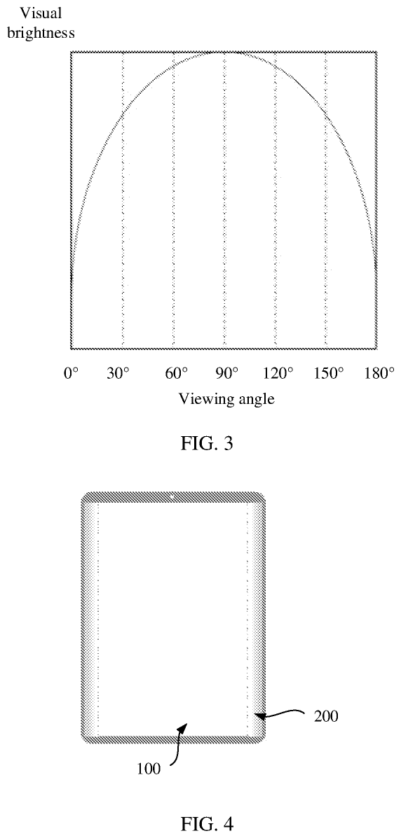

Referring to FIG. 1 to FIG. 4, FIG. 1 is a schematic diagram of a curved screen, that is, the display is a curved screen, and the curved screen includes a curved display area 200; FIG. 2 is an enlarged view of a part A in FIG. 1; FIG. 3 shows change of luminous brightness of a display with change of a viewing angle; and FIG. 4 is a schematic diagram of display brightness attenuation and color cast of a curved screen.

A display area of a display layer in a curved screen includes a curved display area 200 and a main display area 100 except the curved display area 200. The main display area 100 is a screen body area facing a user, and the curved display area 200 is located on two sides of the main display area 100. As shown in FIG. 4, the curved display area 200 extends from an edge of the main display area 100 to a border 300 on two sides, and different positions of the curved display area 200 present different degrees of bending. Based on a plane where the main display area 100 is located, different areas of the curved display area 200 and the plane of the main display area 100 have different included angles, and the included angle is defined as a bending angle θ, where larger bending angle θ indicates a higher bending degree of the area.

A viewing angle defined in this embodiment of this application is an angle between an observer's line of sight and a display area. Then, referring to FIG. 1, when a user views the curved screen, a line of sight faces the main display area 100, that is, the viewing angle is 90 degrees, and the 90-degree viewing angle is a front viewing angle. In this case, an included angle between the line of sight of the user and the curved display area 200 on both sides is definitely greater than or less than 90 degrees. A larger bending angle θ indicates a larger difference between a viewing angle of the user in this area and the front viewing angle.

Referring to FIG. 3 again, when an angle between a line of sight and the display is 90 degrees, that is, in the front viewing angle, the display has maximum brightness. In another viewing angle, brightness of the display decreases to varying degrees as the viewing angle changes, and a larger deviation from the front viewing angle results in a greater display brightness decrease. It can be learned that, if component parameters of all areas of the entire display area of the curved screen are the same, referring to FIG. 3, because of a difference in a viewing angle, the curved display area 200 on both sides definitely have brightness attenuation and color cast, that is, as shown in FIG. 4. It may be understood that, in the curved display area 200, included angles between areas with different bending angles θ of the curved display area 200 and the line of sight of the user are different; and when the user's line of sight is facing the main display area 100, an area with a higher bending degree has a greater difference from the front viewing angle, lower display brightness, and more serious color cast.

Therefore, in this embodiment of this application, a structure parameter of the drive transistor in the drive circuit of the curved display area 200 is set to be different from that of the main display area 100, so that a drive circuit current of the curved display area 200 is different from a drive circuit current of the main display area 100, so as to compensate for a display brightness change or color cast that is subsequently caused by different viewing angles due to bending.

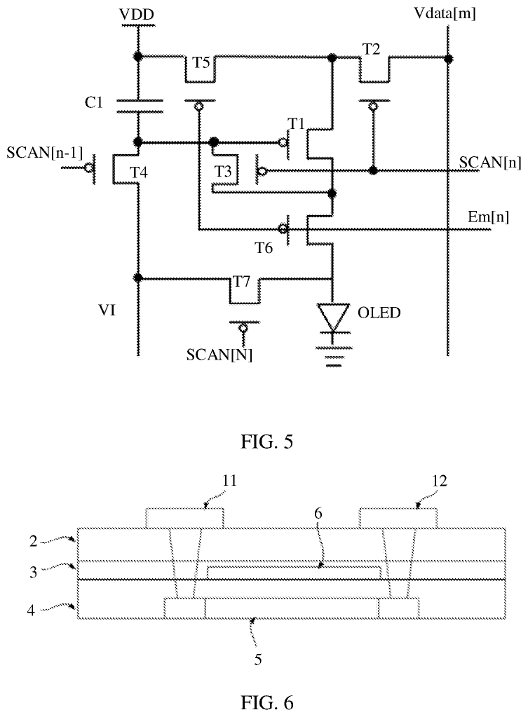

For a principle of adjusting the structure parameters of the drive transistor to change the current of the drive circuit, reference may be further made to FIG. 5 and FIG. 6. FIG. 5 is a schematic diagram of a drive circuit of an OLED display. The drive transistor includes a plurality of transistors: T1, T2, T3, T4, T5, T6, and T7, where T1 operates in a saturation region, plays a drive role, is a drive transistor, and T2-T7 operate in a linear region, and play a switch role. FIG. 6 is a sectional view of the drive transistor T1 in FIG. 5.

The drive circuit shown in FIG. 5 is a drive circuit commonly used in an OLED display, and the drive circuit includes a source voltage VDD, a data voltage Data[m], a scanning signal SCAN[n], a scanning signal SCAN[n-1], an initialization voltage VI, a capacitor C1, a light-emitting signal Em[n], and a light-emitting diode OLED. In an example in which each transistor in the drive circuit in FIG. 4 is a PMOS transistor, corresponding transistors are enabled or disabled by controlling SCAN[n-1], SCAN[n], and Em[n] to change with time, which mainly includes the following several phases:
I. Initialization phase: The transistor T4 is enabled, and charge stored in the capacitor C1 flows into the VI through the transistor T4 to complete an initialization process.
II. Anode reset compensation phase: The transistor T7 is enabled, OLED anode reset is completed, transistors T1, T2, and T3 are enabled, and data signal voltage is written into the capacitor C1 and maintained.
III. Light-emitting phase: Transistors T5 and T6 are enabled, and a VDD voltage is driven. A current flows through a drive transistor Tl through an OLED component to complete light emitting. Because the data signal voltage in the second phase is written into the capacitor C1 and maintained, the voltage is also a gate voltage of the drive transistor T1, and the voltage is controlled by the Vdata[m].

In this case, it can be obtained from a drive principle of the drive circuit that a current I=1/2 uCₒₓW/L(VDD−V_{data})² that flows through the OLED display, where uCₒₓW/L is a structure parameter of the drive transistor T1, and specifically, VDD is a power signal, V_{data} is a data voltage signal, u is a carrier mobility of the drive transistor T1, Cₒₓ is a gate capacitance per unit area of the drive transistor T1, W is a channel width of the drive transistor T1, and L is a channel length.

A channel may be understood with reference to FIG. 6. FIG. 6 shows a cross section of a drive transistor T1 in a drive circuit. The drive transistor Tl includes a source (S electrode, Source) and a drain (D electrode, Drain) 12 that are on two ends, there is a semiconductor between the source 11 and the drain 12, and the semiconductor between the source 11 and the drain 12 is a channel 5. The semiconductor may be P—Si (Polysilicon), that is, polycrystalline silicon. The channel 5 is covered by a first gate insulation layer 4, a gate (Gate) 6 is disposed on the first gate insulation layer 4, and the gate 6 is covered by a second gate insulation layer 3; and an interlayer dielectric layer (ILD, Interlayer dielectric) is disposed on the second gate insulation layer 3. In the foregoing formula, a length L of the channel 5 is a length of a semiconductor between the source 11 and the drain 12 of the drive transistor T1. From a perspective of FIG. 6, a semiconductor size in a vertical direction to a semiconductor length is a width W of the channel 5 at a top viewing angle, and a vertical direction in FIG. 6 is a height direction of the channel 5.

The foregoing formula is described by using a drive circuit shown in FIG. 5 as an example. When the drive circuit changes, 1/2(VDD−V_{data})² in the current formula may change. For example, a value of 1/2 changes, or another parameter may be added to (V_{power}−V_{data}), but regardless of how the drive circuit changes, the current I flowing through the OLED display is definitely positively correlated with uCₒₓW/L.

In conclusion, in this embodiment of this application, to implement current adjustment, only a structure parameter of the drive transistor T1 in the drive circuit is adjusted. Provided that the structure parameter of the drive transistor in the drive circuit is changed, a current provided by the drive circuit to the display can be changed.

For the curved screen, a drive circuit that provides a current for the main display area

100 may be defined as a first drive circuit, and a drive circuit that provides a current for the curved display area 200 may be defined as a second drive circuit. It should be understood that both the main display area 100 and the curved display area 200 include a plurality of pixel units, and therefore, the main display area 100 and the curved display area 200 include a plurality of first drive circuits and a plurality of second drive circuits. In this embodiment of this application, compared with the first drive circuit, structure parameters of a drive transistor of the second drive circuit may be adjusted, to increase a current of the curved display area 200, so as to improve brightness and eliminate color cast. It can be learned that, in this embodiment of this application, display of the display can be optimized and adjusted without increasing manufacturing costs, changing a main structure of the drive circuit, or adjusting circuit control. Certainly, as described above, the curved display area 200 includes areas with different bending angles θ, and degrees of brightness attenuation and color cast are different. Therefore, current designs of areas with different bending angles θ in the curved display area 200 are also different, that is, transistor structure parameter settings of the second drive circuit corresponding to areas with different bending angles θ are also different. It can be learned that this adjustment manner can implement continuous adjustment of brightness and color cast of the display, and has a relatively large design and adjustment space.

As described above, the foregoing mentioned current flowing through the OLED display is I=1/2 uCₒₓW/L(V_{power}−V_{data})², the current I in any bending angle θ of the curved display area 200 is correlated with uCₒₓW/L. It may be learned that, in the second drive circuit corresponding to an area with any bending angle θ, a change of any one of structure parameters u, Cₒₓ, W and L of the drive transistor of the second drive circuit may cause a change of magnitude of a current flowing through the area with the bending angle θ, which leads to brightness attenuation and color cast in the area with the bending angle θ caused by a change of a viewing angle. For details, refer to the following embodiments.

### Embodiment 1

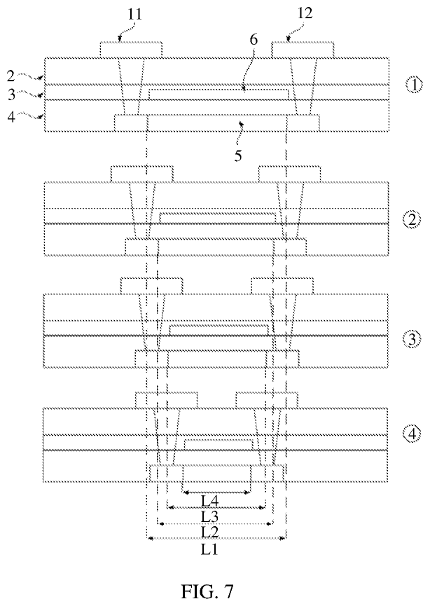

As shown in FIG. 7, FIG. 7 is a schematic diagram showing a comparison of lengths of a channel 5 at different positions in a curved display area 200 of a curved screen in Embodiment 1.

This may be understood with reference to FIG. 3. Four areas of the curved display area 200 are shown in FIG. 3. A first area \textcircled{1} is an area where a bending angle θ1=0, and the area is a start of the curved display area 200 and a boundary area between the curved display area 200 and a main display area 100. A fourth area \textcircled{4} is an area where a bending angle θ4=90 degrees, and the area is an area with a maximum bending degree of the curved display area 200. A second area \textcircled{2} and a third area \textcircled{3} are successively areas with bending angles θ2 and θ3, and are located between the first area \textcircled{1} and the fourth area \textcircled{4}, where θ2<θ3. FIG. 7 shows channel length and width designs corresponding to the four areas in FIG. 3.

It can be learned from the foregoing principle description that a current I of a drive circuit is positively correlated with uCₒₓW/L. When u and Cₒₓ remain unchanged, if the ratio W/L of a width of the channel 5 to a length of the channel 5 of a drive transistor in the drive circuit changes, the supplied current also changes accordingly. In this embodiment, drive transistors of second drive circuits in different areas of the curved display area 200 may be designed based on different bending angles θ. FIG. 7 shows changes of the length L of the channel 5 in four different areas, which are respectively corresponding to the first area \textcircled{1} to the fourth area \textcircled{4} from top to bottom. The length of the channel 5 is gradually reduced, so that W/L is gradually increased, and a corresponding current is continuously increased. It may be learned from FIG. 3 that, from the first area \textcircled{1} to the fourth area \textcircled{4}, the bending angles θ gradually increase. If supplied currents are the same, display brightness gradually decreases, and color cast gradually becomes obvious. Currents in the first area \textcircled{1} to the fourth area \textcircled{4} in Embodiment 1 gradually increase, which can compensate for a difference in viewing angle, so that display brightness of the curved display area 200 and the main display area 100 with different bending angles θ can be consistent with the main display area 100.

It should be noted that a change of a W/L ratio will cause a change of a current. Therefore, the length L of the channel 5 or the width W of the channel 5 in different areas may be separately changed. FIG. 7 shows that a length change of the channel 5 is separately changed. It may be understood that a width may also be separately changed, that is, the width of the channel 5 may be gradually increased from the first area \textcircled{1} to the fourth area \textcircled{4}. Certainly, the length and the width of the channel 50 may also be changed at the same time. Provided that changes of the length and the width of the channel 50 cause a change of the ratio, and then cause a change of a current, so as to adapt to the change in the bending angle θ of the curved display area 200, and finally compensate for the change of the display brightness and the color cast caused by the change of the viewing angle.

### Embodiment 2

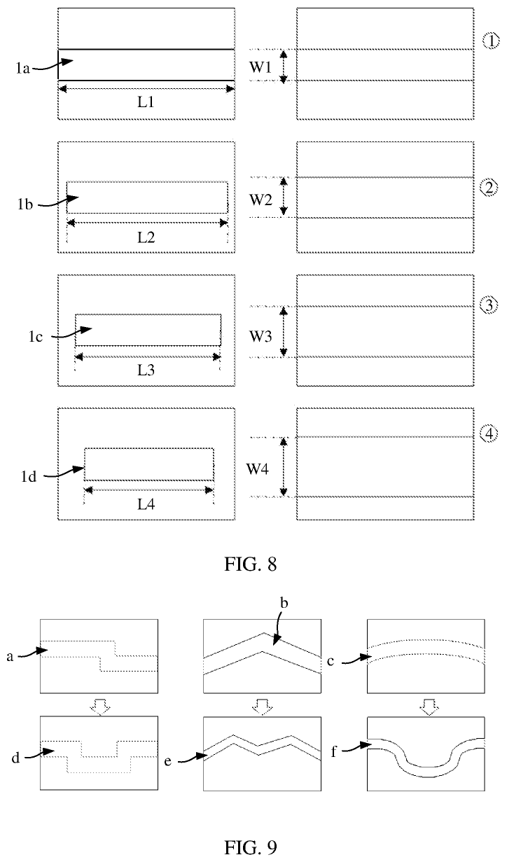

As shown in FIG. 8, FIG. 8 is a schematic diagram of a comparison of channel lengths and widths of areas with different bending angles θ of a curved display area 200 of a curved screen in Embodiment 2. Four figures on the left are schematic diagrams of channel lengths of drive circuits corresponding to the four areas in FIG. 3, and figures on the right are corresponding schematic diagrams of channel widths.

In this embodiment, from a first area \textcircled{1} to a fourth area \textcircled{4}, channels are respectively a channel 1a, a channel 1b, a channel 1c, and a channel 1d. Lengths of the channels are gradually decreased and widths are gradually increased. In this way, W/L is definitely gradually increased, and corresponding currents are continuously increased, so as to achieve the foregoing compensation purpose. Certainly, as the bending angle θ gradually increases, if both the channel length and the width gradually increase or decrease, the purpose of increasing W/L can also be achieved. However, in this case, a specific increase or decrease range needs to be designed, so as to ensure that the W/L ratio changes as expected.

It should be noted that, in Embodiment 1 and Embodiment 2, a change of the W/L ratio of the channel needs to be designed based on a change of the bending angle θ of a corresponding area. Different display types may have different brightness changes or color cast problems in the curved display area 200 due to viewing angle changes, and design needs to be performed in combination with specific products to achieve the purpose of compensation.

In addition, referring to FIG. 9, FIG. 9 is a schematic diagram of a shape change comparison of channels in different areas.

In FIG. 9, three figures in an upper part are schematic diagrams of a drive transistor channel of a first drive circuit in a main display area 100, and may be respectively defined as a first channel a, a second channel b, and a third channel c. Three figures in a lower part are schematic diagrams of drive transistor channels of drive circuits in the curved display area 200, and may be respectively defined as a fourth channel d, a fifth channel e, and a sixth channel f.

In FIG. 9, specifically, when a channel length is increased, a linear distance between two ends of the channel does not change. It may be learned that linear distances between two ends of channel a-f are the same. Only a bending degree of the channel and/or bending times of the channel are/is increased to increase a channel length. The channel length is a total path length that extends from one end of the channel to the other end. In FIG. 9, the first channel a has one bend, which is roughly Z-shaped, and the fourth channel d below the first channel a has two bends, which is roughly inverted Ω-shaped. In this case, a length of the fourth channel d is greater than a length of the first channel a. In FIG. 9, the second channel b in the middle is an inverted V-shaped structure, and the fifth channel e below the second channel b is an M-shaped structure, which is equivalent to increasing bending times. In this case, a length of the fifth channel e is greater than a length of the second channel b. In FIG. 9, the third channel c on the rightmost side is arc-shaped, and the sixth channel f below the third channel c continues to be concave in the middle of the arc shape, and a degree of bending is increased. In this case, a length of the sixth channel f is greater than a length of the third channel c.

It can be learned that the shorter first channel a, second channel b, or third channel c in FIG. 9 may be used as channels that drive a drive transistor of the curved display area 200, and the longer fourth channel e, fifth channel f, or sixth channel g may be used as channels that drive a drive transistor of the main display area 100.

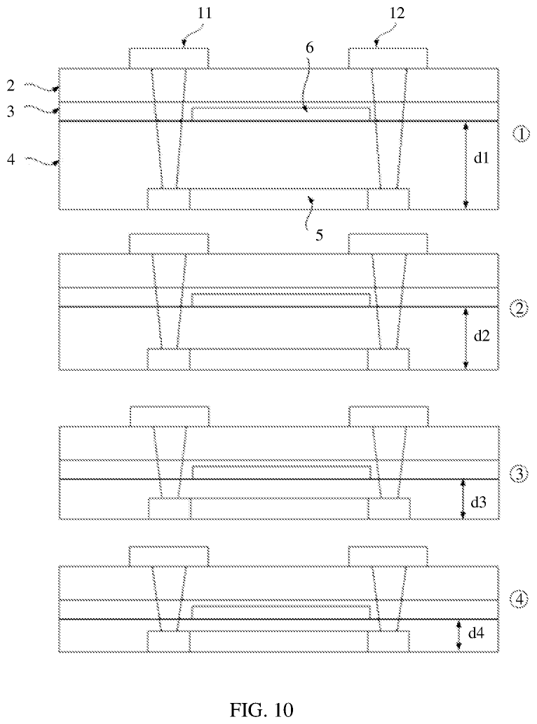

It can be learned that the increase or decrease of the channel length and width is not limited to extension or shortening in corresponding length and width directions, but a change design of the length and width may be implemented by means of a shape change. In this way, a design of the drive transistor may be more flexible. For example, when a size of the drive transistor in a channel length direction is limited, the channel may be extended by increasing a quantity of bending times or increasing bending degrees. Therefore, channel layout may be performed based on a size condition of the drive transistor and location distribution of another circuit element. In addition, a shape change is not limited to changing a length of a channel. In FIG. 10, a width of the fifth channel e decreases when a length increases compared with the second channel b, and a width of the sixth channel f decreases when a length increases compared with the third channel c, that is, a shape change may cause changes in both width and length.

### Embodiment 3

As shown in FIG. 10, FIG. 10 is a schematic diagram showing a comparison of thicknesses of first gate insulation layers 4 of areas with different bending angles θ in a curved display area 200 of a curved screen in Embodiment 3.

It can be learned from the foregoing principle description that a current I of a drive circuit is positively correlated with uCₒₓW/L. When u and W/L remain unchanged, a change of the gate capacitance per unit area Cₒₓ with different bending angles θ may also realize a change of the current. In a formula Cₒₓ=λε₀ε_{GI1}/d_{GI1}, ε₀ is a vacuum permittivity, ε_{GI1} is a permittivity of the first gate insulation layer 4, and d_{GI1} is a thickness of the first gate insulation layer 4. According to the formula, Cₒₓ is inversely proportional to the thickness d_{GI1} of the first gate insulation layer 4. As shown in FIG. 10, corresponding to the four areas with different bending angles θ1, θ2, θ3, and θ4 in FIG. 3, thicknesses of the first gate insulation layers 4 are respectively d1, d2, d3, and d4, and d1, d2, d3, and d4 gradually decrease as the bending angle θ gradually increases, to ensure that the currents gradually increase, so that a current change meets a brightness and color cast change requirements, and display quality of each area is consistent. It may be learned that a change of another parameter in the gate capacitance per unit area Cₒₓ may also cause a change of a current, for example, the permittivity ε_{GI1} of the first gate insulation layer 4 is changed. In this embodiment, a purpose of changing a current in a corresponding area can be achieved by changing only the thickness of the first gate insulation layer 4, and the design is simple.

### Embodiment 4

As shown in FIG. 11, FIG. 11 is a schematic diagram showing a comparison of sizes of semiconductor film grains 5a of areas with different bending angles θ in a curved display area 200 of a curved screen in Embodiment 4.

It can be learned from the foregoing principle description that a current I of a drive circuit is positively correlated with uCₒₓW/L. A carrier mobility u changes with different bending angles θ, and when u and W/L remain unchanged, a current of a display area in an area with a bending angle θ also correspondingly changes. It can be learned from semiconductor knowledge that a carrier mobility u of a semiconductor is affected by factors such as a size of a film grain of the semiconductor, doping density, and a defect status. As shown in FIG. 11, figures from left to right respectively correspond to semiconductor structures of drive transistors in drive circuits in the first area \textcircled{1} to the fourth area \textcircled{4} in FIG. 3, and sizes of film grains of the semiconductors gradually increase. A larger semiconductor film grain 5a indicates a higher carrier mobility u. In this case, the size of the film grain 5a of the semiconductor of the drive transistor in the corresponding drive circuit can be controlled by a process, to control a semiconductor carrier mobility u in a corresponding area, so that a current of the corresponding area meets brightness and color cast change requirements, and display quality of each area is consistent.

In the foregoing embodiment, a length and a width of a channel may be changed separately or simultaneously. Actually, for all parameters u, Cₒₓ, W and L that affect the current, they may be changed separately, or at least two parameters may be changed synchronously. This is not limited in this embodiment of this application, provided that a comprehensive result after the change adapts to the change of the bending angle θ, so that the display effect of the corresponding area is consistent with that under the front viewing angle.

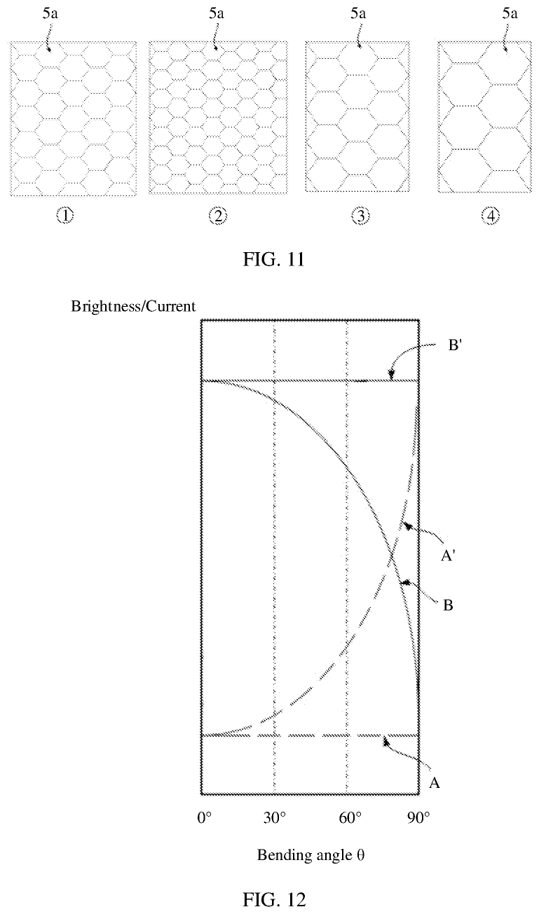

Referring to FIG. 12, FIG. 12 is a schematic diagram showing a comparative relationship between a current change and a display brightness change in areas with different bending angles θ of a display. A straight line A is a first current curve, indicating that each area of the curved display area has a same current. A curve A′ is a second current curve, indicating that currents provided by each area of the curved display area 200 gradually increase with increase of the curved angle θ. A straight line B is a first display brightness curve, indicating that display brightness of each area of the curved display area 200 is consistent. A dashed line B′ is a second display brightness curve, indicating that display brightness gradually decrease with increase of the curved angle θ.

A and B indicate an existing drive circuit arrangement solution. In this embodiment

of this application, structure parameters of a drive transistor of a drive circuit are changed to adjust currents in areas with different bending angles θ, and currents are supplied according to the curve A′, so that display brightness of the curved display area 200 is consistent with that of the main display area 100, and is presented as the straight line B′.

In addition, it may be understood that, in this embodiment of this application, the curved display area shown in FIG. 2 is used as a schematic basis to lead to a difference in viewing angle, and then causes a problem of display brightness attenuation and color cast. However, the display in this embodiment of this application is not limited to the curved screen structure shown in FIG. 2. Provided that a display includes display areas with different included angles, for example, a first display area and a second display area as defined, a difference in viewing angle is inevitable when a user simultaneously views the first display area and the second display area, and then a display of one display area has problems of display brightness attenuation and color cast compared with a display of the other display area. In this case, current magnitude of a corresponding position may be adjusted by changing structure parameters of a drive transistor of a drive circuit of a position where display brightness is attenuated and color cast is generated, to achieve a purpose of compensating for a difference in display effects. Actually, in the foregoing embodiment, the main display area 100 is the first display area, and an area with any bending angle θ in the curved display area 200 is the second display area.

It should be noted that the display in this embodiment of this application is described by using an OLED screen as an example. It may be understood that the display may be another type of display, such as a liquid crystal display (liquid crystal display, LCD) or a light-emitting diode (light-emitting diode, LED) display. Provided that the display is driven by a drive circuit, the current can be adjusted by changing the structure parameters of the drive transistor in the drive circuit.

In this embodiment of this application, a display of a mobile phone is used as an example for description. It may be learned that a display may be disposed in another electronic device. For example, the electronic device may alternatively be a mobile terminal such as a wearable device, an in-vehicle device, an augmented reality (augmented reality, AR)/virtual reality (virtual reality, VR) device, an ultra-mobile personal computer (ultra-mobile personal computer, UMPC), a netbook computer, or a personal digital assistant (personal digital assistant, PDA), or may be a professional photographing device such as a digital camera, a single-lens reflex camera/micro single camera, a motion camera, a cloud station camera, or a drone, provided that the electronic device is provided with a display. This is not specifically limited in this application.

In addition, an embodiment of this application further provides a method for manufacturing a display, to process and manufacture the display according to any one of the foregoing embodiments. When a channel (that is, a semiconductor) of a drive transistor is processed, a thin film of amorphous silicon or polycrystalline silicon can be formed through chemical vapor deposition or physical vapor deposition. During deposition, channels with different lengths or widths are obtained by changing shapes of deposition areas corresponding to drive transistors of a first drive circuit and a second drive circuit. For a display, the shape of the deposition area may be designed in advance as a whole, so that drive circuits with different structure parameters can be processed as a whole, and the processing is simple.

In addition, in an example in which semiconductors with different sizes of film grains 5a need to be processed in Embodiment 4, a semiconductor of a drive transistor may be processed by using an excimer laser annealing process, and a semiconductor a-silicon (that is, amorphous silicon) formed by using the foregoing deposition process is processed into required polycrystalline silicon. In this process, laser scanning time, laser energy, and laser scanning times affect a size of a film grain of the semiconductor. For example, increasing laser energy and laser scanning time may increase a grain size. When a semiconductor of a drive transistor of a first drive circuit and a drive transistor of a second drive circuit are manufactured, semiconductors with different sizes of film grains may be obtained by adjusting at least one of the foregoing parameters. In addition, as shown in FIG. 2, for a mobile phone with a display, all drive circuit arrays are usually designed in an array. When semiconductors of drive transistors in each drive circuit are processed, laser scanning may be performed column by column. Therefore, for a mobile phone with a curved screen, each bending angle of a curved display area 200 of the mobile phone corresponds to one row of drive circuits. In this case, when laser scanning is performed on a row of drive circuits at each bending angle in the curved display area 200, a process parameter adjustment may be performed, and the operation is relatively simple.

The principle and implementations of this application are described herein based on specific examples. The descriptions about the embodiments are merely intended to help understand the method and the core concept of this application. It should be noted that a person of ordinary skill in the art may make several improvements or modifications without departing from the principle of this application, and these improvements or modifications shall fall within the protection scope of this application.

1. An electronic device, comprising a display, wherein the display comprises a first display area and a second display area that have an included angle, a first drive circuit provides a current for the first display area, a second drive circuit provides a current for the second display area, both the first drive circuit and the second drive circuit are provided with a drive transistor, and at least one structure parameter of the drive transistor of the first drive circuit and the drive transistor of the second drive circuit is different to provide different currents.

2. The electronic device according to claim 1, wherein the structure parameters comprise u, Cₒₓ, W, and L, wherein L is a channel length, W is a channel width, u is a carrier mobility, Cₒₓ is a gate capacitance per unit area, and a current provided by the drive circuit is positively correlated with uCₒₓW/L.

3. The electronic device according to claim 2, wherein a linear distance between two ends of a channel of the drive transistor of the first drive circuit and a linear distance between two ends of a channel of the drive transistor of the second drive circuit are the same, and the channels have different bending degrees or bending times to have different channel lengths.

4. The electronic device according to claim 2, wherein the drive transistor of the first drive circuit and the drive transistor of the second drive circuit have different grain sizes of semiconductor films to have different carrier mobility.

5. The electronic device according to claim 2, wherein the drive transistor comprises a channel and a first gate insulation layer covering the channel; and the drive transistor of the first drive circuit and the drive transistor of the second drive circuit have different thicknesses of first gate insulation layers to have different gate capacitance per unit area.

6. The electronic device according to claim 1, wherein a current provided by a corresponding drive circuit of one of the first display area and the second display area that has lower display brightness may be greater than a current provided by the other drive circuit.

7. The electronic device according to claim 1, wherein the display is a curved screen, the curved screen comprises a curved display area and a main display area, the main display area is the first display area, and an area with any bending angle in the curved display area is the second display area.

8. The electronic device according to claim 7, wherein in the curved display area, at least one structure parameter of the drive transistor of the second drive circuit corresponding to areas with different bending angles is different, and a larger bending angle indicates a higher current provided by the second drive circuit.

9. The electronic device according to claim 7, wherein a plurality of first drive circuits are corresponding to the main display area, and structure parameters of drive transistors in the plurality of first drive circuits are the same.

10. The electronic device according to claim 1, wherein the display is an organic light-emitting display, a liquid crystal display, or a light-emitting diode display.

11. (canceled)

12. A method for manufacturing a display, wherein the display comprises a first display area and a second display area that have an included angle, a first drive circuit that provides a current for the first display area, and a second drive circuit that provides a current for the second display area; and both the first drive circuit and the second drive circuit are provided with a drive transistor, and when the drive transistor of the first drive circuit and the drive transistor of the second drive circuit are processed, at least one structure parameter of the drive transistor of the first drive circuit and the drive transistor of the second drive circuit is different to provide different currents.

13. The method for manufacturing a display according to claim 12, wherein the structure parameters comprise u, Cₒₓ, W, and L, wherein L is a channel length, W is a channel width, u is a carrier mobility, Cₒₓ is a gate capacitance per unit area, and a current provided by the drive circuit is positively correlated with uCₒₓW/L.

14. The method for manufacturing a display according to claim 13, wherein semiconductors of the drive transistor of the first drive circuit and the drive transistor of the second drive circuit are processed by using an excimer laser annealing process, and when the drive transistor of the first drive circuit and the drive transistor of the second drive circuit are processed, a process parameter is adjusted, so that grain sizes of semiconductor films of the drive transistor of the first drive circuit and the drive transistor of the second drive circuit are different; and the process parameters comprise: laser scanning time, laser energy, and laser scanning times.

15. The method for manufacturing a display according to claim 14, wherein the display is a curved screen, the curved screen comprises a curved display area and a main display area, the main display area is the first display area, and an area with any bending angle in the curved display area is the second display area; and both the first drive circuit and the second drive circuit are designed in an array, and each area with a bending angle of the curved display area is corresponding to one column of second drive circuits; and
during processing, each column of the first drive circuits and the second drive circuits are sequentially scanned, and when the drive transistor of the second drive circuit is scanned, at least one of the process parameters is adjusted.
